(19) United States
(12) Patent Application Publication
(10) Pub. No.: US 2018/0182421 A1
(43) Pub. Date: Jun. 28, 2018

(54) MAGNETIC RECORDING MEDIUM AND MAGNETIC STORAGE APPARATUS

(71) Applicant: SHOWA DENKO K.K., Tokyo (JP)

(72) Inventors: Takayuki FUKUSHIMA, Chiba (JP); Kazuya NIWA, Chiba (JP); Lei ZHANG, Chiba (JP); Yuji MURAKAMI, Chiba (JP); Hisato SHIBATA, Chiba (JP); Takehiro YAMAGUCHI, Chiba (JP); Tetsuya KANBE, Chiba (JP)

(21) Appl. No.: 15/841,930

(22) Filed: Dec. 14, 2017

(30) Foreign Application Priority Data
Dec. 27, 2016 (JP) 2016-254004

(51) Int. Cl. G11B 5/667; G11B 11/105; G11B 5/65; G11B 5/73

(52) U.S. Cl. CPC G11B 5/667; G11B 11/10589; G11B 5/851; G11B 5/7325; G11B 5/65

(57) ABSTRACT

A magnetic recording medium includes a substrate, an underlayer, and a magnetic layer including an alloy having a L1₀ type crystal structure with a (001) orientation, wherein the substrate, the underlayer, and the magnetic layer are stacked in this order, the underlayer includes a first underlayer, the first underlayer is a crystalline layer that includes a material containing W as a main component and a nitride whose content ranges from 1 mol % to 80 mol %, and the nitride includes one or more elements selected from a group consisting of Al, B, Si, Ti, Zr, Hf, V, Nb, Ta, Cr, Mo, and W.

### CROSS-REFERENCE TO RELATED APPLICATION

The present application is based upon and claims priority to Japanese Patent Application No. 2016-254004, filed on Dec. 27, 2016, the entire contents of which are incorporated herein by reference.

### BACKGROUND OF THE INVENTION

### 1. Field of the Invention

The disclosures herein generally relate to a magnetic recording medium and a magnetic storage apparatus.

### 2. Description of the Related Art

In recent years, demand for increasing the storage capacity of hard disk drives has been growing.

However, with existing recording methods, it is difficult to increase the recording density of hard disk drives.

A heat-assisted magnetic recording method is a technique that has been actively studied and attracted attention as a next generation recording method. The heat-assisted magnetic recording method is a recording method in which a magnetic head irradiates a magnetic recording medium with near-field light to partially heat the surface of the magnetic recording medium, such that the coercivity of the magnetic recording medium can be reduced and thereby the magnetic recording medium can be written.

When a high Ku material is used as a material of a magnetic layer, KuV/kT increases. Ku is a magnetic anisotropy constant of magnetic particles, V is a volume of magnetic particles, k is the Boltzmann constant, and T is temperature. Accordingly, the volume of the magnetic particles can be reduced without increasing thermal fluctuation. In the heat-assisted magnetic recording method, fine magnetic particles allow transition width to be narrowed. As a result, noise can be reduced and a signal-to-noise ratio (SNR) can be improved.

Also, in order to obtain a heat-assisted magnetic recording medium having high perpendicular magnetic anisotropy, an alloy having an L1₀ type crystal structure, which is used as a material constituting the magnetic layer, is required to have a (001) orientation. Because the (001) orientation of the magnetic layer is controlled by an underlayer, a material of the underlayer is required to be appropriately selected.

As a material of the underlayer of the heat-assisted magnetic recording medium, MgO, CrN, TiN, and the like are conventionally known.

For example, Patent Document 1 discloses a method for producing an information recording medium in which an underlayer containing MgO as its main component is made, and further an L1₀ type ordered alloy layer made of an FePt alloy is made.

Also, Patent Document 2 discloses a magnetic recording medium that includes a magnetic recording layer including dots formed of a magnetic material such as FePt having an L1₀ structure and CoPt having an L1₀ structure, and also including a non-magnetic region. Such a magnetic recording layer is formed on an underlayer formed of a transition metal nitride such as TiN, ZrN, HfN, and CrN. Further, Patent Document 3 discloses a magnetic recording medium that includes underlayers including both a MgO underlayer that contains MgO and has a (100) orientation, and a nitride underlayer that contains at least one nitride selected from TaN, NbN, and HfN and has a (100) orientation. The magnetic recording medium also includes a magnetic layer that is formed on the underlayers and contains an alloy having a L1₀ type crystal structure as its main component.

Moreover, Patent Document 4 discloses a magnetic recording medium that includes a crystalline underlayer containing W as its main component and containing B, Si, C, or an oxide, and also includes a magnetic layer containing an alloy having a L1₀ structure as its main component.

### RELATED-ART DOCUMENTS

### Patent Documents

[Patent Document 1] Japanese Laid-Open Patent Publication No. 11-353648

[Patent Document 2] Japanese Laid-Open Patent Publication No. 2009-146558

[Patent Document 3] Japanese Laid-Open Patent Publication No. 2013-257930

[Patent Document 4] Japanese Laid-Open Patent Publication No. 2014-220029

In the heat-assisted magnetic recording medium, in order to obtain favorable magnetic recording characteristics, the magnetic layer including an alloy having the L1₀ type crystal structure is required to have a (001) orientation, as described above.

However, in conventional techniques, because of a poor (001) orientation of a magnetic layer, a signal-to-noise ratio (SNR) has been insufficient.

### SUMMARY OF THE INVENTION

It is an object of one aspect of the present invention to provide a magnetic recording medium having a high signal-to-noise ratio (SNR).

According to an aspect of an embodiment, a magnetic recording medium includes a substrate, an underlayer, and a magnetic layer including an alloy having a L1₀ type crystal structure with a (001) orientation, wherein the substrate, the underlayer, and the magnetic layer are stacked in this order, the underlayer includes a first underlayer, the first underlayer is a crystalline layer that includes a material containing W as a main component and a nitride whose content ranges from 1 mol % to 80 mol %, and the nitride includes one or more elements selected from a group consisting of Al, B, Si, Ti, Zr, Hf, V, Nb, Ta, Cr, Mo, and W.

According to an aspect of the embodiment, a magnetic storage apparatus includes the above-described magnetic recording medium.

Other objects and further features of the present invention will be apparent from the following detailed description when read in conjunction with the accompanying drawings.

### BRIEF DESCRIPTION OF THE DRAWINGS

FIG. 1 is a schematic diagram illustrating an example of a magnetic recording medium of an embodiment;

FIG. 2 is a schematic diagram illustrating an example of a magnetic storage apparatus of the embodiment; and

FIG. 3 is a schematic diagram illustrating an example of a magnetic head of FIG. 2.

### DESCRIPTION OF THE PREFERRED EMBODIMENTS

In the following, embodiments of the present invention will be described with reference to the accompanying drawings. The present invention is not limited to the embodiments as will be described below, and various variations and modifications may be made without departing from the scope of the present invention.

### (Magnetic Recording Medium)

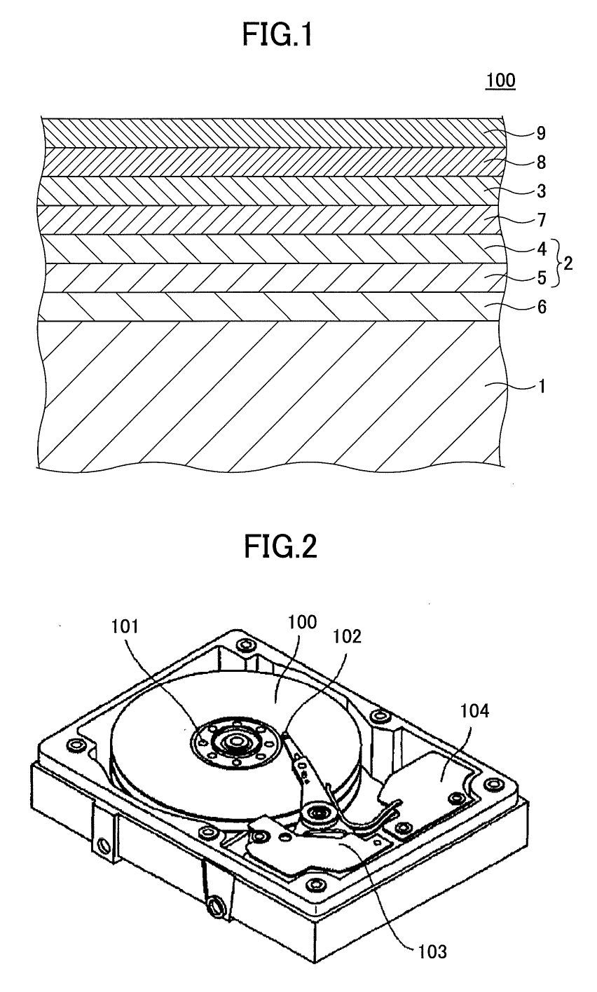

FIG. 1 illustrates an example of a magnetic recording medium of an embodiment.

A magnetic recording medium 100 includes a substrate 1, an underlayer 2, and a magnetic layer 3 including an alloy having a L1₀ type crystal structure with a (001) orientation. The substrate 1, the underlayer 2, and the magnetic layer 3 are stacked in this order. The underlayer 2 includes a first underlayer 4. The first underlayer 4 is a crystalline layer that includes a material containing W as its main component and a nitride whose content ranges from 1 mol % to 80 mol %. The nitride includes one or more elements selected from a group consisting of Al, B, Si, Ti, Zr, Hf, V, Nb, Ta, Cr, Mo, and W.

By adopting the above-described configuration, the magnetic recording medium 100 can enhance the (001) orientation of the magnetic layer 3. Accordingly, a magnetic recording medium having a high SNR can be provided. Herein, W included in the first underlayer 4 has a body-centered cubic (BCC) lattice structure and thus has a high (100) orientation. This allows the (001) orientation of the alloy constituting the magnetic layer 3 and having the L1₀ type crystal structure to be enhanced. Also, the nitride included in the first underlayer 4 can enhance a lattice match between the first underlayer 4 and the magnetic layer 3 without degrading the crystallinity and the (100) orientation of W.

In the present description and the claims, the material containing W as its main component refers to a material with a W content of at least 50 at. %. In the material containing W as its main component, the content of W is preferably at least 70 at. % and more preferably at least 90 at. %.

Examples of the material containing W as its main component included in the first underlayer 4 include, but are not limited to, W, WMo, WCu, WNi, WFe, WRe, and WC.

Examples of the nitride included in the first underlayer 4 include, but are not limited to, AlN, BN, Si₃N₄, TiN, ZrN, HfN, VN, NbN, TaN, CrN, MoN, and WN.

In the present embodiment, the content of the nitride in the first underlayer 4 ranges from 1 mol % to 80 mol %. In a case where the content of the nitride in the first underlayer 4 exceeds 80 mol %, the (100) orientation of the first underlayer 4 becomes poor. In a case where the content of the nitride in the first underlayer 4 is less than 1 mol %, it becomes difficult to enhance the (001) orientation of the magnetic layer 3.

In the present embodiment, preferably, the content of the nitride in the first underlayer 4 ranges from 20 mol % to 30 mol %. Preferably, a nitride including Ti, Zr, or Ta is used. By adopting this configuration, the (001) orientation of the magnetic layer 3 can be further enhanced.

In the present embodiment, the underlayer 2 has a two-layer structure. As a second underlayer 5, a crystalline layer containing W as its main component is provided between the substrate 1 and the first underlayer 4. The first underlayer 4 includes the material containing W as its main component as described above, and has a BCC structure. Therefore, the first underlayer 4 has a high (100) orientation and is lattice-matched with the magnetic layer 3, which is formed above the first underlayer 4 and includes the alloy having the L1₀ type crystal structure with the (001) orientation. By providing the crystalline layer containing W as its main component as the second underlayer 5 under the first underlayer 4, the crystallization and the (100) orientation of the first underlayer 4 can be further enhanced.

In the present description and the claims, the crystalline layer containing W as its main component refers to a crystalline layer with a W content of at least 50 at. %. In the crystalline layer containing W as its main component, the content of W is preferably at least 70 at. % and more preferably at least 90 at. %.

Examples of the crystalline layer containing W as its main component include, but are not limited to, a W layer, a WMo layer, a WCu layer, a WNi layer, a WFe layer, a WRe layer and a WC layer.

In the present embodiment, an orientation control layer 6 is provided between the substrate 1 and the underlayer 2. The orientation control layer is a Cr layer having a BCC structure, an alloy layer containing Cr as its main component and having a BCC structure, or an alloy layer having a B2 structure. The orientation control layer 6 has the (100) orientation because the orientation control layer 6 is a layer for ensuring the (100) orientation of the underlayer 2 formed on the orientation control layer 6.

In the present description and the claims, the alloy containing Cr as its main component refers to an alloy with a Cr content of at least 50 at. %. In the alloy containing Cr as its main component, the content of Cr is preferably at least 70 at. % and more preferably at least 90 at. %.

Examples of the alloy containing Cr as its main component include, but are not limited to, a CrMn alloy, a CrMo alloy, a CrW alloy, a CrV alloy, a CrTi alloy, and a CrRu alloy.

Further, in order to improve the size and the dispersity of crystal grains of the underlayer 2, an element such as B, Si, and C may be added to the alloy containing Cr as its main component. However, in a case where such an element is added, the element is preferably added to an extent that the crystallization of the orientation control layer 6 is not deteriorated.

Moreover, examples of the alloy having a B2 structure include a RuAl alloy and a NiAl alloy.

In the present embodiment, a barrier layer is provided between the underlayer 2 and the magnetic layer 3.

The barrier layer 7 includes one or more compounds selected from a group consisting of MgO, TiO, NiO, TiN, TaN, HfN, NbN, ZrC, HfC, TaC, NbC, and TiC, and has a NaCl type structure.

In the present embodiment, as the magnetic layer 3, a magnetic layer including the alloy having the L1₀ type crystal structure with the (001) orientation is used. In order to promote the ordering of the magnetic layer 3, the substrate 1 may be heated when the magnetic layer 3 is formed. The barrier layer 7 is a layer for suppressing the interfacial diffusion generated between the underlayer 2 and the magnetic layer 3.

In the present embodiment, the alloy constituting the magnetic layer 3 and having the L1₀ type crystal structure has a high magnetic anisotropy constant Ku.

Examples of the alloy having the L1₀ type crystal structure include a FePt alloy and a CoPt alloy.

In order to promote the ordering of the magnetic layer 3, a heating process may be preferably performed when the magnetic layer 3 including the alloy having the L1₀ type crystal structure with the (001) orientation is formed. In this case, Ag, Au, Cu, and Ni, and the like may be added to the alloy having the L1₀ type crystal structure such that the heating temperature (ordering temperature) decreases.

Also, crystal grains of the alloy having the L1₀ type crystal structure included in the magnetic layer 3 are preferably magnetically isolated. Therefore, the magnetic layer 3 preferably contains one or more materials selected from a group consisting of SiO₂, TiO₂, Cr₂O₃, Al₂O₃Ta₂O₅, ZrO₂, Y₂O₃, CeO₂, MnO, TiO, ZnO, B₂O₃, C, B, and BN. This further ensures separation of exchange couplings between crystal grains, allowing the SNR of the magnetic recording medium 100 to be further improved.

A carbon protective layer 8 and a lubricant layer 9 made of a perfluoropolyether-based resin are provided on the magnetic layer 3.

Generally known materials can be used for the carbon protective layer 8 and the lubricant layer 9.

Further, the second underlayer 5, the orientation control layer 6, the barrier layer 7, the carbon protective layer 8, and the lubricant layer 9 may be omitted as necessary.

Further, a heat sink layer may be provided to quickly cool the magnetic layer 3.

The heat sink layer may be formed of a metal having high heat conductivity such as Ag, Cu, Al, and Au, or may be formed of an alloy containing, as its main component, a metal having high heat conductivity such as Ag, Cu, Al, and Au.

For example, the heat sink layer can be formed under the orientation control layer 6 or can be formed between the orientation control layer 6 and the barrier layer 7.

Further, a soft magnetic layer may be provided to improve write characteristics.

Examples of the material of the soft magnetic layer include, but are not limited to, an amorphous alloy such as a CoTaZr alloy, a CoFeTaB alloy, a CoFeTaSi alloy, and a CoFeTaZr alloy, a microcrystalline alloy such as an FeTaC alloy and an FeTaN alloy, and a polycrystalline alloy such as a NiFe alloy.

The soft magnetic layer may be formed by a single layer film or may have a multi-layer film structure in which layers are antiferromagnetically coupled via a Ru layer of a suitable thickness.

In addition to the above-described layers, other layers such as a seed layer and a bonding layer may be provided as necessary.

The magnetic recording medium 100 may be suitably used as a magnetic recording medium employing the heat-assisted magnetic recording method, or a magnetic recording medium employing the microwave-assisted recording method.

### (Magnetic Storage Apparatus)

An example of a configuration of a magnetic storage apparatus of the present embodiment will be described.

In the present embodiment, the example of the configuration of the magnetic storage apparatus employing the heat-assisted magnetic recording method will be described. However, the magnetic storage apparatus of the present embodiment is not limited to the magnetic storage apparatus employing the heat-assisted magnetic recording method. The magnetic storage apparatus employing the microwave-assisted recording method may be used.

The magnetic storage apparatus of the present embodiment includes the magnetic recording medium of the present embodiment.

For example, the magnetic storage apparatus may include a magnetic recording medium driving part configured to rotate the magnetic recording medium, and a magnetic head having a near-field light generating element on its tip. Further, the magnetic storage apparatus may also include a laser generating part configured to heat the magnetic recording medium, a waveguide configured to guide laser light generated by the laser generating part to the near-field light generating element, a magnetic head driving part configured to move the magnetic head, and a recording/reproducing signal processing system.

FIG. 2 illustrates an example of the magnetic storage apparatus of the present embodiment.

The magnetic storage apparatus illustrated in FIG. 2 includes the magnetic recording medium 100, a magnetic recording medium driving part 101 configured to rotate the magnetic recording medium 100, a magnetic head 102, a magnetic head driving part 103 configured to move the magnetic head, and a recording/reproducing signal processing system 104.

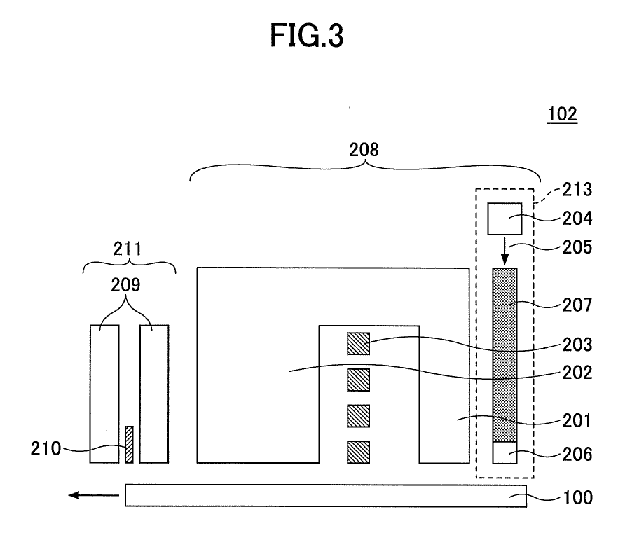

FIG. 3 illustrates an example of the magnetic head 102.

The magnetic head 102 includes a recording head 208 and a reproducing head 211.

The recording head 208 includes a main magnetic pole 201, an auxiliary magnetic pole 202, a coil 203 that generates a magnetic field, a laser diode (LD) 204 that forms a laser generating part, and a waveguide 207 that transmits laser light 205 generated by the LD to a near-field light generating element 206.

The reproducing head 211 includes a reproducing element 210 sandwiched between shields 209.

The magnetic storage apparatus illustrated in FIG. 2 uses the magnetic recording medium 100, allowing the SNR to be improved and the magnetic storage apparatus having a high recording density to be provided.

### EXAMPLES

Although a description will be given of specific examples, the present invention is not limited to these specific examples.

### Example 1

A magnetic recording medium 100 (see FIG. 1) was produced. A process for producing the magnetic recording medium 100 will be described below.

As a seed layer, a film made of Cr-50 at. % Ti (an alloy with a CR content of 50 at. % and a Ti content of 50 at. %) and having a thickness of 25 nm was formed on a glass substrate 1 having an outer diameter of 2.5 inches. The substrate 1 was heated at 300° C. Subsequently, as an orientation control layer 6, a film made of Cr-5 at. % Mn (an alloy with a Cr content of 95 at. % and a Mn content of 5 at. %) was formed. Next, as a second underlayer 5, a W layer having a thickness of 20 nm was formed. As a first underlayer 4, a film made of W-20TaN (an alloy with a W content of 80 mol % and a TaN content of 20 mol %) was formed on the second underlayer 5. Further, as a barrier layer 7, a MgO film having a thickness of 2 nm was formed. Subsequently, the substrate 1 was heated at 580° C. As a magnetic layer 3, a film made of (Fe-45 at. % Pt)-12 mol % SiO₂-6 mol % BN (an alloy with an FePt alloy content of 82 mol % in which a Fe content is 55 at. % and a Pt content is 45 at. %, a SiO₂ content of 12 mol %, and a BN content of 6 mol %) and having a thickness of 10 nm was formed. Further, a carbon protective layer 8 having a thickness of 3 nm was formed. A lubricant layer 9 made of a perfluoropolyether-based fluororesin was formed on the surface of the carbon protective layer 8. Accordingly, the magnetic recording medium 100 was produced.

### Examples 2 Through 5

Magnetic recording mediums were produced in the same manner as Example 1, except that the composition of the first underlayer 4 was changed to W-25TaN, W-30TaN, W-50TaN, and W-75TaN, respectively.

### Examples 6 Through 16

Magnetic recording mediums were produced in the same manner as Example 1, except that the composition of the first underlayer 4 was changed to W-25ZrN, W-25TiN, W-25VN, W-25NbN, W-25AlN, W-25BN, W-25Si3N4, W-25HfN, W-25CrN, W-25MoN, and W-25WN, respectively.

### Example 17

A magnetic recording medium was produced in the same manner as Example 2, except that the second underlayer 5 was not formed.

### Examples 18 Through 20

Magnetic recording mediums were produced in the same manner as Example 2, except that the composition of the second underlayer 5 was changed to W-10Mo (alloy with a W content of 90 at. % and a Mo content of 10 at. %), W-20Mo, and W-30Mo, respectively.

### Comparative Example 1

A magnetic recording medium was produced in the same manner as Example 1, except that the first underlayer 4 was not formed.

### Comparative Examples 2 and 3

Magnetic recording mediums were produced in the same manner as Example 17 and Example 1, respectively, except that the composition of the first underlayer 4 was changed to TiN.

### Comparative Examples 4 and 5

Magnetic recording mediums were produced in the same manner as Example 17 and Example 1, respectively, except that the composition of the first underlayer 4 was changed to TaN.

### Comparative Examples 6 and 7

Magnetic recording mediums were produced in the same manner as Example 17 and Example 1, respectively, except that the composition of the first underlayer 4 was changed to W-8Si (alloy with a W content of 92 at. % and a Si content of 8 at. %).

### Comparative Examples 8 and 9

Magnetic recording mediums were produced in the same manner as Example 17 and Example 1, respectively, except that the composition of the first underlayer 4 was changed to W-8SiO₂ (alloy with a W content of 92 mol % and a SiO₂ content of 8 at. %).

### (Signal Intensity of FePt (001) Peak)

Using an X-ray diffractometer, the signal intensity of the FePt (001) peak was obtained by measuring X-ray diffraction spectra of a sample of a magnetic recording medium after a step of forming the magnetic layer 3 is completed.

### (SNR)

The SNR was measured by recording an all-one pattern signal with a linear recording density of 1500 kFCI on a magnetic recording medium by using the magnetic head 102 (see FIG. 3). Power supplied to the laser diode was adjusted such that a track width MWW, which was defined as the half width of a track profile, was 60 nm.

Table 1 illustrates evaluation results of signal intensities of the FePt (001) peak and SNRs.

TABLE 1

| | | | SIGNAL | |
|---|---|---|---|---|
| | FIRST | SECOND | INTENSITY | |
| | UNDER- | UNDER- | OF FePt | SNR |
| | LAYER | LAYER | (001) PEAK | [dB] |
| EXAMPLE 1 | W-20TaN | W | 154 | 9.0 |
| EXAMPLE 2 | W-25TaN | W | 167 | 9.2 |
| EXAMPLE 3 | W-30TaN | W | 175 | 9.4 |
| EXAMPLE 4 | W-50TaN | W | 150 | 8.6 |
| EXAMPLE 5 | W-75TaN | W | 158 | 8.7 |
| EXAMPLE 6 | W-25ZrN | W | 180 | 8.6 |
| EXAMPLE 7 | W-25TiN | W | 149 | 8.5 |
| EXAMPLE 8 | W-25VN | W | 147 | 8.3 |
| EXAMPLE 9 | W-25NbN | W | 152 | 8.4 |
| EXAMPLE 10 | W-25AlN | W | 150 | 8.2 |
| EXAMPLE 11 | W-25BN | W | 155 | 8.4 |
| EXAMPLE 12 | W-25Si₃N₄ | W | 145 | 8.1 |
| EXAMPLE 13 | W-25HfN | W | 156 | 8.6 |
| EXAMPLE 14 | W-25CrN | W | 155 | 8.5 |
| EXAMPLE 15 | W-25MoN | W | 153 | 8.4 |
| EXAMPLE 16 | W-25WN | W | 157 | 8.6 |
| EXAMPLE 17 | W-25TaN | — | 147 | 8.3 |
| EXAMPLE 18 | W-25TaN | W-10Mo | 165 | 9.2 |
| EXAMPLE 19 | W-25TaN | W-10Mo | 161 | 9.1 |
| EXAMPLE 20 | W-25TaN | W-10Mo | 155 | 9.0 |
| COMPARATIVE | — | W | 135 | 7.8 |
| EXAMPLE 1 | | | | |
| COMPARATIVE | TaN | — | 125 | 7.5 |
| EXAMPLE 2 | | | | |
| COMPARATIVE | TaN | W | 140 | 8.0 |
| EXAMPLE 3 | | | | |
| COMPARATIVE | TiN | — | 107 | 7.0 |
| EXAMPLE 4 | | | | |
| COMPARATIVE | TiN | W | 111 | 7.3 |
| EXAMPLE 5 | | | | |
| COMPARATIVE | W-8Si | — | 124 | 7.5 |
| EXAMPLE 6 | | | | |
| COMPARATIVE | W-8Si | W | 132 | 7.8 |
| EXAMPLE 7 | | | | |
| COMPARATIVE | W-8SiO₂ | — | 127 | 7.7 |
| EXAMPLE 8 | | | | |
| COMPARATIVE | W-8SiO₂ | W | 138 | 8.0 |
| EXAMPLE 9 | | | | |

As seen from Table 1, the magnetic recording mediums according to Examples 1 through 20 have high signal intensities of the FePt (001) peak and high SNRs.

Conversely, the magnetic recording medium according to the comparative example 1 has a low signal intensity of the FePt (001) peak and a low SNR because the first underlayer 4 was not formed.

The magnetic recording mediums according to the comparative examples 2 through 5 have low signal intensities of the FePt (001) peak and low SNRs because the first underlayer 4 does not include W.

The magnetic recording mediums according to the comparative examples 6 through 9 have low signal intensities of the FePt (001) peak and low SNRs because the first underlayer 4 does not include a nitride.

According to at least one embodiment, a magnetic recording medium having a high signal-to-noise ratio (SNR) can be provided.

Further, the present invention is not limited to these embodiments, but various variations and modifications may be made without departing from the scope of the present invention.

What is claimed is:

1. A magnetic recording medium comprising:
a substrate;
an underlayer; and
a magnetic layer including an alloy having a L1₀ type crystal structure with a (001) orientation,
wherein the substrate, the underlayer, and the magnetic layer are stacked in this order,
the underlayer includes a first underlayer,
the first underlayer is a crystalline layer that includes a material containing W as a main component and a nitride whose content ranges from 1 mol % to 80 mol %, and
the nitride includes one or more elements selected from a group consisting of Al, B, Si, Ti,
Zr, Hf, V, Nb, Ta, Cr, Mo, and W.

2. The magnetic recording medium according to claim 1, wherein
the content of the nitride in the first underlayer ranges from 20 mol % to 30 mol %, and
the nitride includes Ti, Zr, or Ta.

3. The magnetic recording medium according to claim 1, wherein
the underlayer further includes a second underlayer, and
the second underlayer is a crystalline layer provided between the substrate and the first underlayer and containing W as a main component thereof.

4. The magnetic recording medium according to claim 1, further comprising:
an orientation control layer between the substrate and the underlayer,
wherein the orientation control layer is a Cr layer having a BCC structure, an alloy layer containing Cr as a main component and having a BCC structure, or an alloy layer having a B2 structure.

5. The magnetic recording medium according to claim 1, further comprising:
a barrier layer between the underlayer and the magnetic layer,
wherein the barrier layer includes one or more compounds selected from a group consisting of MgO, TiO, NiO, TiN, TaN, HfN, NbN, ZrC, HfC, TaC, NbC, and TiC, and has a NaCl type structure.

6. A magnetic storage apparatus comprising the magnetic recording medium according to claim 1.
